(19) United States
(12) Patent Application Publication
(10) Pub. No.: US 2009/0251723 A1
(43) Pub. Date: Oct. 8, 2009

(54) IMAGE PROCESSING APPARATUS, IMAGE FORMING SYSTEM, IMAGE PROCESSING METHOD AND COMPUTER READABLE MEDIUM STORING PROGRAM

(75) Inventor: Masatomo Igarashi, Saitama-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/336,914

(22) Filed: Dec. 17, 2008

(30) Foreign Application Priority Data
Apr. 2, 2008 (JP) 2008-095779

(51) Int. Cl. G06F 3/12

(52) U.S. Cl. 358/1.15

(57) ABSTRACT

An image processing apparatus includes: plural drawing processing units that perform the image processing based on designation of an image processing command which designates plural input types of image processing; and a determination unit that determines whether the respective image processing designated with the image processing command is performed by one of the plurality of drawing processing units, or performed by the plurality of drawing processing units, based on image processing time necessary for execution of the respective image processing designated with the image processing command. The image processing apparatus also includes a power source controller that, in a case where the determination unit determines that the respective image processing designated with the image processing command is performed by one of the plurality of drawing processing units, reduces power consumption of other drawing processing units than the one drawing processing unit, in comparison with a case where the respective image processing designated with the image processing command is performed by the plurality of drawing processing units.

### CROSS-REFERENCE TO RELATED APPLICATIONS

This application is based on and claims priority under 35 USC 119 from Japanese Patent Application No. 2008-095779 filed Apr. 2, 2008.

### BACKGROUND

### Technical Field

The present invention relates to an image processing apparatus, an image forming system, an image processing method and a computer readable medium storing a program.

### SUMMARY

According to an aspect of the present invention, there is provided an image processing apparatus including:

a plurality of drawing processing units that perform the image processing based on designation of an image processing command, the image processing command designating a plurality of input types of image processing;

a determination unit that determines whether the respective image processing designated with the image processing command is performed by one of the plurality of drawing processing units, or performed by the plurality of drawing processing units, based on image processing time necessary for execution of the respective image processing designated with the image processing command; and

a power source controller that, in a case where the determination unit determines that the respective image processing designated with the image processing command is performed by one of the plurality of drawing processing units, reduces power consumption of other drawing processing units than the one drawing processing unit, in comparison with a case where the respective image processing designated with the image processing command is performed by the plurality of drawing processing units.

### BRIEF DESCRIPTION OF THE DRAWINGS

An exemplary embodiment of the present invention will be described in detail based on the following figures, wherein:

FIG. 1 is a block diagram showing a system configuration of an image forming system according to an exemplary embodiment of the present invention;

FIG. 2 is a block diagram showing a functional configuration of a controller 10 in the image forming system according to the exemplary embodiment of the present invention;

FIG. 3 is a block diagram showing a hardware configuration of an image processing device 12 in the image forming system according to the exemplary embodiment of the present invention;

FIG. 4 is a block diagram showing a configuration of a drawing processor 61 in the image forming system according to the exemplary embodiment of the present invention;

FIG. 5 is a table showing an example of an image processing command transmitted from a system control CPU 31 to a drawing control CPU 32;

FIG. 6 is a table as an example of a processing time table used by a system controller 41 for calculation of time necessary for execution of respective image processing;

FIG. 7 is a flowchart showing an operation of the image processing device 12 in the image forming system according to the exemplary embodiment of the present invention;

FIG. 8 is a table showing an example of calculation of processing time by referring to the processing time table shown in FIG. 6 regarding the image processing command shown in FIG. 5;

FIG. 9 is a flowchart showing the details of determination of the number of necessary drawing processors (step S102) shown in the flowchart of FIG. 7; and

FIG. 10 is a table showing changes of the number of necessary drawing processors in correspondence with required processing time.

### DETAILED DESCRIPTION

Next, an exemplary embodiment of the present invention will be described in detail with reference to the drawings.

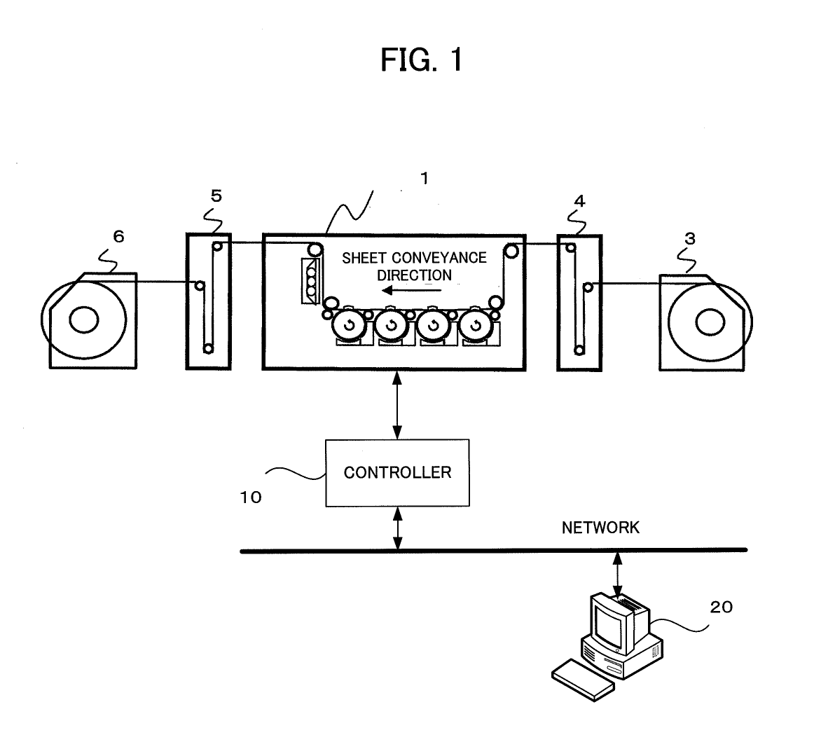

FIG. 1 is a block diagram showing an example of a system configuration of an image forming system according to the exemplary embodiment of the present invention. As shown in FIG. 1, the image forming system has a preprocessing device 3, a buffer device 4, a printing apparatus 1 which performs printing on a continuous sheet, a buffer device 5, a post-processing device 6, a controller 10, and a terminal device 20.

The preprocessing device 3 feeds an unprinted continuous sheet, which is in a rolled status, to the printing apparatus 1 as its preprocessing. The post-processing device 6 receives the continuous sheet, which has been subjected to printing and sent from the printing apparatus 1, and rolls the continuous sheet up as its post-processing. The buffer devices 4 and 5 are provided for absorption of a difference between a speed of conveyance of the continuous sheet by the preprocessing device 3 or the post-processing device 6 and a speed of conveyance of the continuous sheet in the printing apparatus 1, so as to maintain a constant tension of the continuous sheet between the buffer devices.

The terminal device 20 generates a print instruction for a print job so as cause the printing apparatus 1 to perform printing on a continuous sheet, and transmits the print job and the print instruction via a network to the controller 10. The controller 10 functions as a print controller which converts the print job into image data in a format printable for the printing apparatus 1, i.e., raster image data, in accordance with the print job and the print instruction transmitted from the terminal device 20 and controls a printing operation of the printing apparatus 1 such that the raster image data is print-outputted by the printing apparatus 1 on a continuous sheet. Note that the raster data represents an image, divided into grid-shaped fine points (pixels), with numeric values indicating colors and densities of the fine points using a color system such as RGB or YMCK system. The printing apparatus 1 print-outputs image data corresponding to the print instruction on the continuous sheet based on the control by the controller 10.

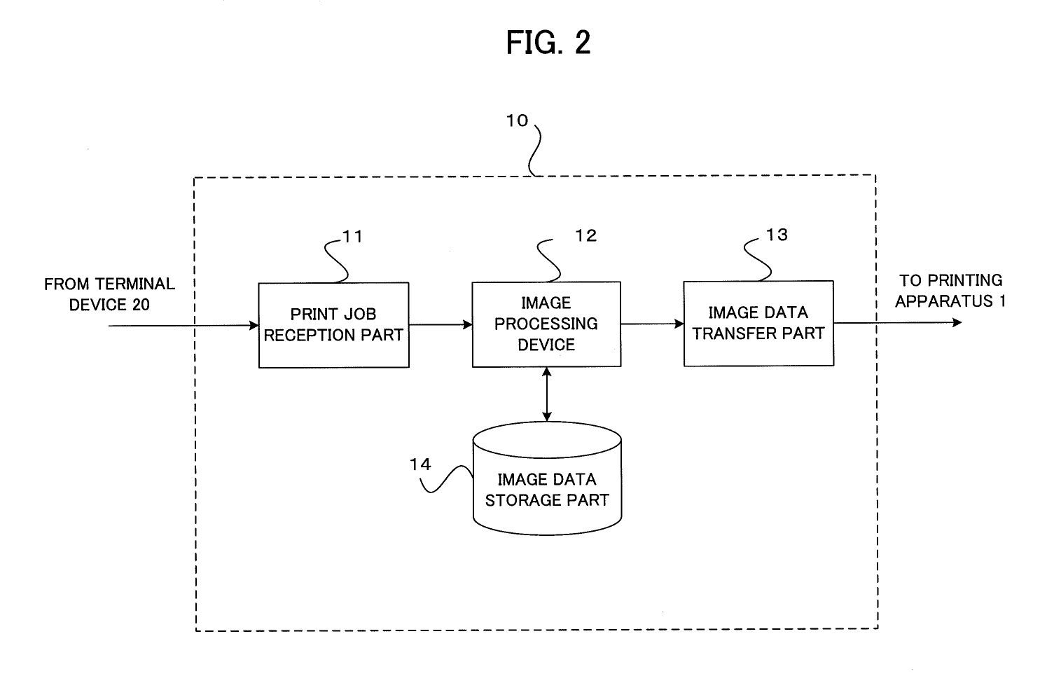

FIG. 2 is a block diagram showing a functional configuration of the controller 10 shown in FIG. 1.

As shown in FIG. 2, the controller 10 has a print job reception part 11, an image processing device 12, an image data transfer part 13, and an image data storage part 14.

The print job reception part 11 receives a print job transmitted from the terminal device 20. The image processing device 12 performs designated various image processing on the print job received by the print job reception part 11, converts the print job into raster image data as image data in a format printable for the printing apparatus 1, and stores the raster image data into the image data storage part 14. The image data transfer part 13 transfers the print data subjected to image processing, stored in the image data storage part 14, to the printing apparatus 1.

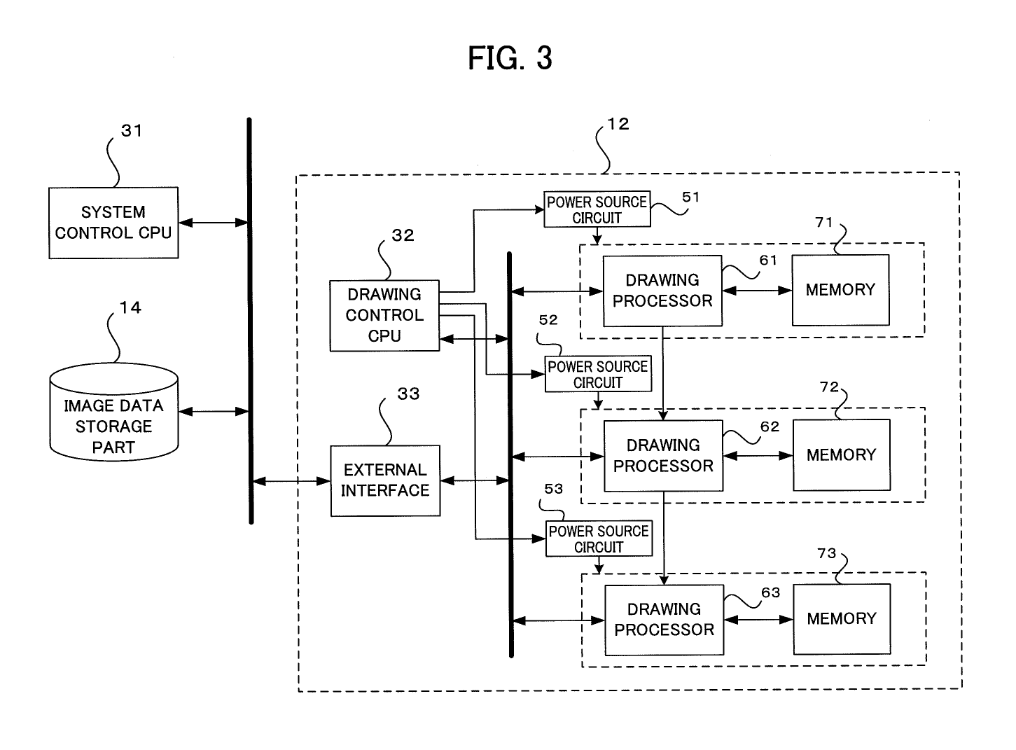

Next, FIG. 3 shows a hardware configuration of the image processing device 12. As shown in FIG. 3, the image processing device 12 has a drawing control CPU 32, an external interface 33, power source circuits 51 to 53, drawing processors 61 to 63, and memories 71 to 73. The drawing control CPU 32 is used as an example of a determination unit, and the drawing processors 61 to 63 are used as an example of drawing processing units.

Note that in the present exemplary embodiment, drawing processing is performed by three drawing processors 61 to 63 for the sake of simplification of explanation; however, the present invention is not limited to this number of drawing processors. For example, the present invention is similarly applicable to drawing processing performed by four or more drawing processors.

Further, it may be arranged such that processing by the drawing control CPU 32 is performed by the drawing processor 61, and the drawing control CPU 32 is omitted. That is, the drawing processor 61 may operate as a master of the drawing processors 62 and 63.

The system control CPU 31 is a CPU which controls the operation of the controller 10. The system control CPU 31 transmits an image processing command thereby causes the image processing device 12 to perform various image processing.

The external interface 33 is a communication interface for data transmission/reception to/from the system control CPU 31 and the image data storage part 14.

When the drawing control CPU 32 receives an image processing command (image processing request) from the system control CPU 31, the drawing control CPU 32 controls the drawing processors 61 to 63 to perform image processing required with the image processing command.

Note that the drawing control CPU 32 controls the operation of the image processing device 12 by performing predetermined processing based on a control program stored in a memory or storage device (not shown). Note that it may be arranged such that the control program is stored in a portable storage medium such as a CD-ROM and provided to the drawing control CPU 32.

The drawing processors (drawing processing units) 61 to 63 are processors to perform image processing designated with the drawing control CPU 32.

The memories 71 to 73 are provided in correspondence with the drawing processors 61 to 63. Image data processed by the drawing processors 61 to 63 is temporarily stored in the memories 71 to 73.

The drawing processors 61 to 63 respectively can directly transfer image data subjected to image processing to another drawing processor by pipeline processing. By the pipeline processing, the drawing processors independently perform the respective processing, such that a process of the next command is started before completion of a series of processing based on a previous command in a manner of flow system.

The power source circuits 51 to 53 supply power to the drawing processors 61 to 63 and the memories 71 to 73 based on control by the drawing control CPU 32. The drawing control CPU 32 can turn ON/OFF the powers of the drawing processors 61 to 63 and the memories 71 to 73 independently by controlling the power source circuits 51 to 53.

The drawing control CPU 32 determines a minimum number of drawing processors necessary to satisfy requirements of the image processing command, from the three drawing processors 61 to 63, in correspondence with the contents of the image processing command received from the system control CPU 31. The image processing command is used as an example of an image processing command.

Then the drawing control CPU 32 performs power source control so as to reduce power consumption by the drawing processor(s) other than drawing processor(s) determined as necessary processor(s) to satisfy the requirements of the image processing command. More particularly, the drawing control CPU 32 reduces power consumption by turning OFF the power of (blocking the power to) the drawing processor(s) other than the drawing processor(s) determined as necessary processor(s) to satisfy the requirements of the image processing command by controlling the power source circuits 51 to 53. The power source circuits 51 to 53 are used as an example of a power source controller.

Note that when the drawing processors 61 to 63 have a mode to reduce power consumption such as a power saving mode (power saving status), it may be arranged such that the drawing control CPU 32 reduces power consumption not by turning OFF the power to the drawing processor(s) determined as unnecessary processor(s) to satisfy the requirements of the image processing command, but changing the drawing processor(s) determined as unnecessary processor(s) into the power saving mode.

Next, a particular method for the drawing control CPU 32 to determine the number of drawing processors necessary to satisfy requirements of the image processing command will be described.

The image processing command, transmitted from the system control CPU 31, includes required processing time as time within which completion of execution of image processing is required. The drawing control CPU 32 determines drawing processors necessary to perform required image processing within the required processing time, from the three drawing processors 61 to 63, by calculating necessary image processing time by each image processing content included in the image processing command.

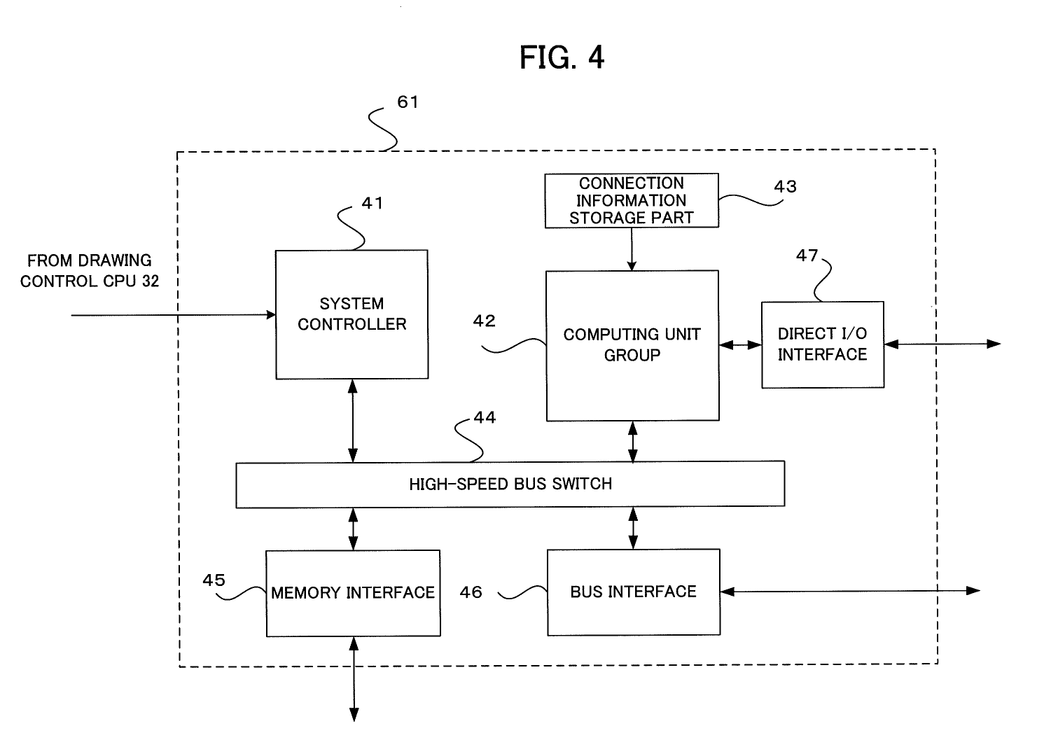

Next, the configuration of the drawing processor 61 will be described with reference to FIG. 4. In the following description, only the drawing processor 61 will be described; however, the drawing processors 62 and 63 have the same configuration.

As the drawing processor 61, a processor capable of dynamically selecting a circuitry in the chip (dynamic reconfigurable processor) is used.

As shown in FIG. 4, the drawing processor 61 has a system controller 41, a computing unit group 42, a connection information storage part 43, a high-speed bus switch 44, a memory interface 45, a bus interface 46, and a direct I/O interface 47.

The computing unit group 42 has various computing units such as an adder and a multiplier. The connection information storage part 43 holds connection information to realize an image processing function by combination of the various computing units of the computing unit group 42.

The system controller 41 operates as a function realization unit which realizes a required image processing function by combining the various computing units of the computing unit group 42 based on the connection information stored in the connection information storage part 43, in correspondence with a request from the drawing control CPU 32.

The memory interface 45 is an interface for data transmission/reception to/from the memory 71. The bus interface 46 is an interface for data transmission/reception to/from another circuit or the like connected to the outside. The direct I/O interface 47 is an interface for direct transfer of image data to the drawing processor 62 by pipeline processing.

The high-speed bus switch 44 is a bus switch for high-speed switching of data path between the system controller 41 and the computing unit group 42, and the memory interface 45 and the bus interface 46.

The drawing processors 61 to 63, having the above configuration, can realize respective designated image processing functions in a short time.

Next, the operation of the image forming system according to the present exemplary embodiment will be described in detail with reference to the drawings.

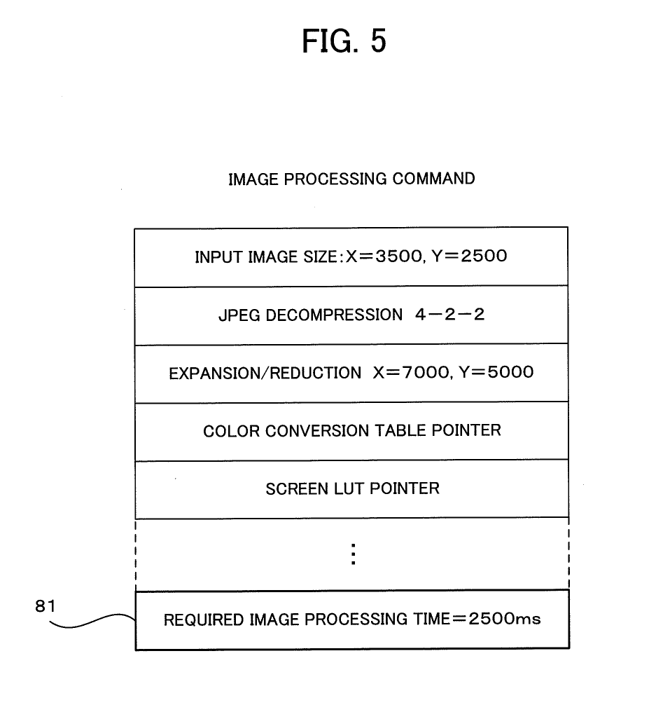

In the following description, an image processing command as shown in FIG. 5 is transmitted from the system control CPU 31 to the drawing control CPU 32.

In the image processing command shown in FIG. 5, the input image size is lateral 3500 dots×vertical 2500 dots. The decompression format upon JPEG (Joint Photographic Experts Group) decompression is 4-2-2. It is required that an original image is converted to lateral 7000 dots×vertical 5000 dots image by expansion/reduction processing. Further, in the image processing command, a pointer to designate a color conversion table used in color conversion processing, and a pointer to designate a screen LUT (Look Up Table) used in screen processing are indicated. Further, in the image processing command, as required image processing time 81 as limited time from start of the image processing to the completion of the processing, 2500 ms is set.

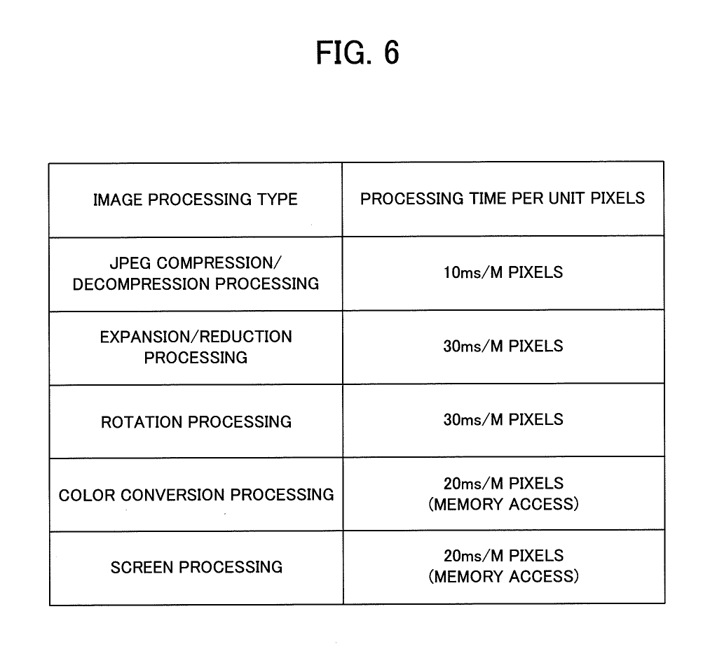

FIG. 6 shows a processing time table used by the system controller 41 for calculation of time necessary for execution of respective image processing. In FIG. 6, 10 ms processing time per 1 M pixels is required for JPEG decompression processing; 30 ms processing time per 1 M pixels is required for expansion/reduction processing; and 30 ms processing time per 1 M pixels is required for rotation processing. Further, when image data stored in a memory is accessed and color conversion processing is performed on the image data, 20 ms processing time per 1 M pixels is required; and when screen processing is performed, 20 ms processing time per 1 M pixels is required. Note that when pipeline processing is performed for direct processing on image data transferred from another drawing processor, it is not necessary to consider the processing times for the color conversion processing and the screen processing.

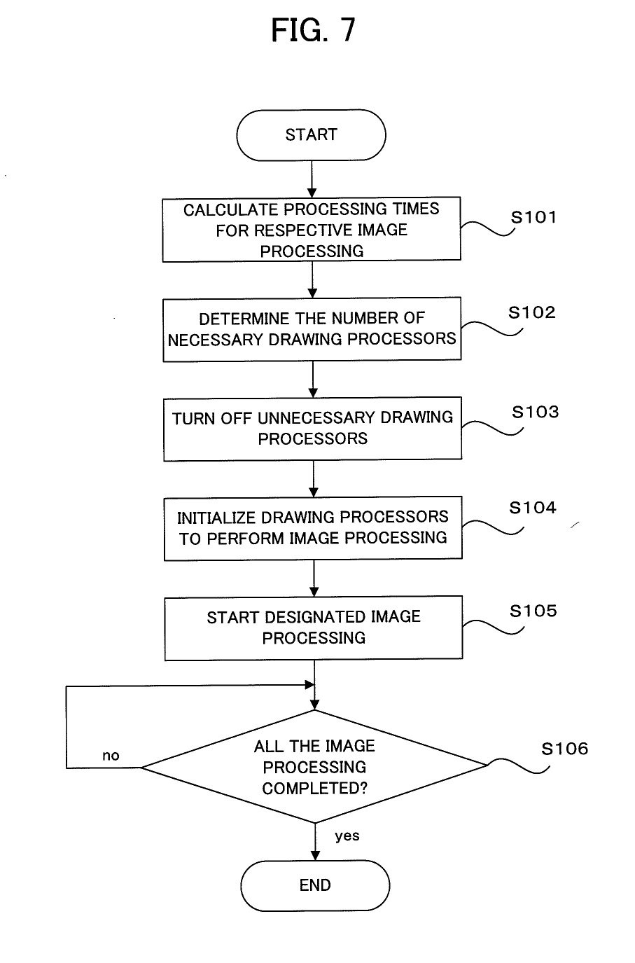

FIG. 7 is a flowchart showing the operation of the image processing device 12 when the drawing control CPU 32 receives an image processing command as shown in FIG. 5.

The drawing control CPU 32, which has received the image processing command from the system control CPU 31, first calculates processing time necessary for execution of respective image processing required with the image processing command by referring to the processing time table as shown in FIG. 6 (step S101).

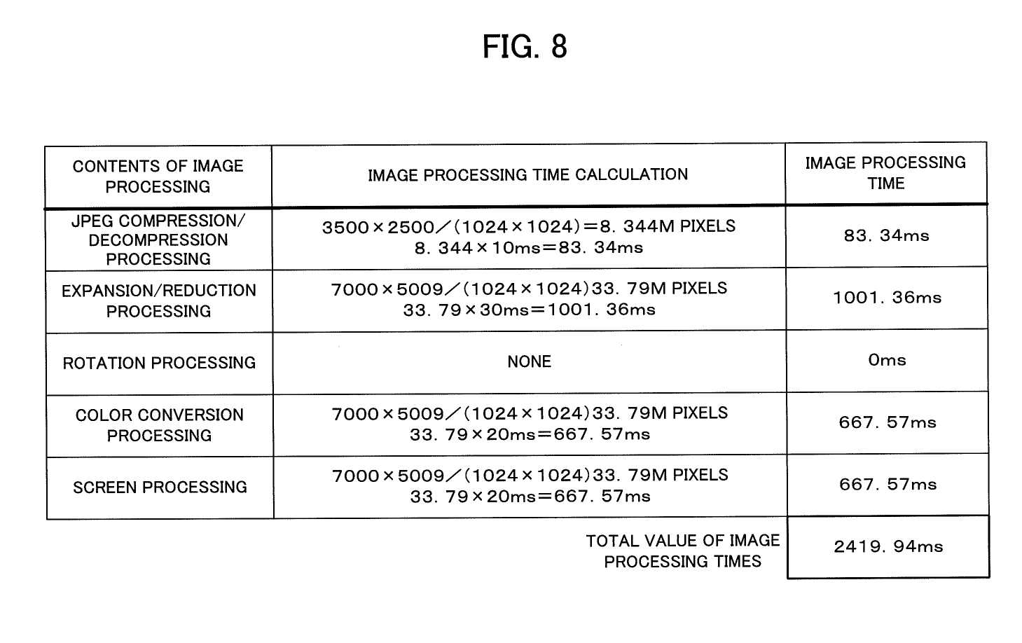

FIG. 8 shows an example of calculation of processing time by referring to the processing time table shown in FIG. 6 regarding the image processing command shown in FIG. 5. In FIG. 8, for example, processing time necessary for JPEG decompression processing is calculated as 83.34 ms. The 83.34 ms processing time is used as an example of calculated value of image processing time necessary for execution of image processing included in the image processing command. Note that in the image processing command shown in FIG. 5, as rotation processing is not included, time for execution of the rotation processing is not calculated in FIG. 8.

Next, the drawing control CPU 32 determines the number of drawing processors necessary for execution of all the image processing within the required processing time included in the image processing command based on the calculated processing times, and determines drawing processors in charge of the respective image processing (step S102). The details of the determination of the number of necessary drawing processors will be described later.

When the drawing processors necessary to realize the requirements of the image processing command have been determined, the drawing control CPU 32 issues commands to the power source circuits among the power source circuits 51 to 53 provided for unnecessary drawing processors to stop power supply (step S103). By this operation, power supply to the drawing processors other than the drawing processors necessary to realize the requirements of the image processing command is blocked.

Then, the drawing control CPU 32 performs initialization processing on the drawing processors determined to be used to realize the requirements of the image processing command, to realize respective corresponding image processing functions (step S104).

In the drawing processor initialized by the drawing control CPU 32, connection information to realize the designated image processing is read from the connection information storage part 43, and performed for the computing unit group 42, and the required image processing function is realized. Then, in the respective drawing processors, designated image processing is started with respect to input image data (step S105).

Then, in the respective drawing processors, when all the designated image processing has been performed, the processing is terminated (step S106).

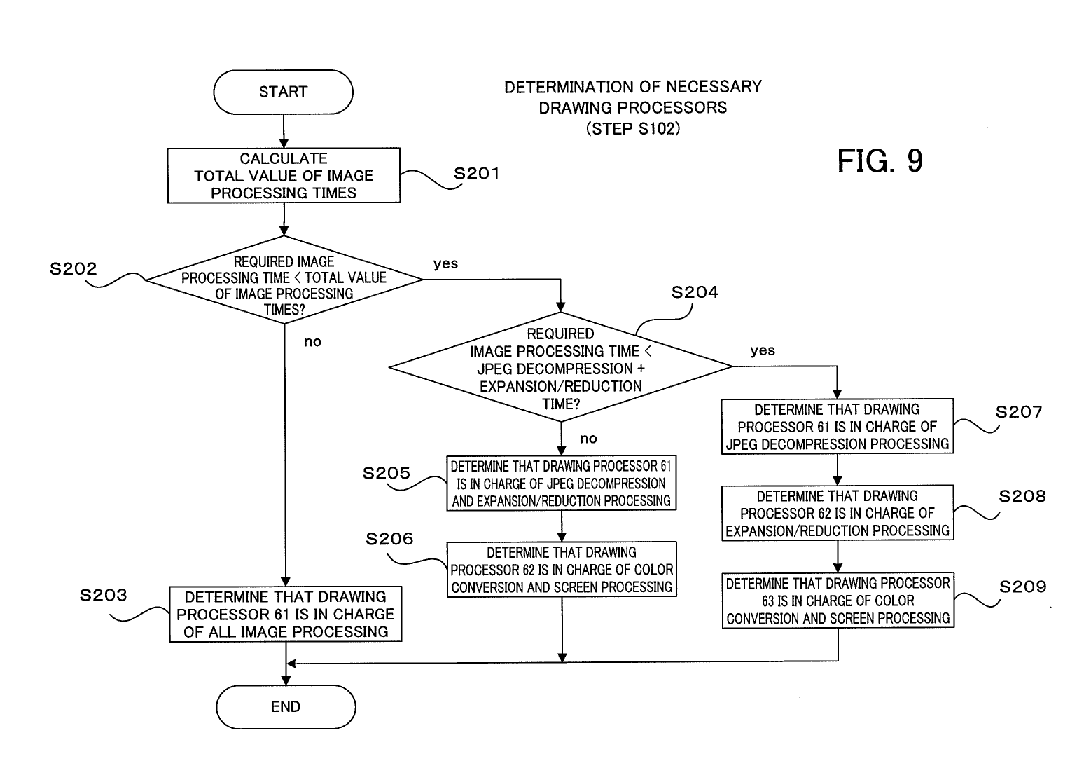

Next, the details of the determination of the number of necessary drawing processors (step S102) shown in the flowchart of FIG. 7 will be described with reference to the flowchart of FIG. 9.

When processing times for the respective image processing included in the image processing command have been calculated by the method as shown in FIG. 8, the drawing control CPU 32 calculates a total value of all the image processing times (step S201). Then, the drawing control CPU 32 determines whether or not the total value of the image processing times is longer than the required image processing time (step S202).

The step S202 is used as an example of determination as to whether the respective image processing designated with the image processing command is performed by one of the plural drawing processing units or the respective image processing designated with the image processing command is performed by the plural drawing processing units, based on the image processing times necessary for execution of the respective image processing designated with the image processing command.

At step S202, when it is determined that the total value of the image processing times is equal to or shorter than the required image processing time (No at step S202), it is possible to complete all the image processing by one drawing processor within the required image processing time. Accordingly, the drawing control CPU 32 determines that the drawing processor 61 is in charge of all the image processing (step S203).

Note that when it is determined that only the drawing processor 61 is in charge of all the image processing, the powers of the drawing processors 62 and 63 are turned OFF.

At step S202, when it is determined that the total value of the image processing times is longer than the required image processing time (Yes at step S202), it is impossible to complete all the image processing by one drawing processor within the required image processing time. Accordingly, the drawing control CPU 32 determines whether or not the total value of the processing times for the JPEG decompression processing and the expansion/reduction processing is longer than the required image processing time (step S204).

At step S204, when it is determined that the total value of the processing times for the JPEG decompression processing and the expansion/reduction processing is equal to or shorter than the required image processing time (No at step S204), it is possible to complete the JPEG decompression processing and the expansion/reduction processing by one drawing processor within the required image processing time. Accordingly, the drawing control CPU 32 determines that the drawing processor 61 is in charge of the JPEG decompression processing and the expansion/reduction processing (step S205). Then, the drawing control CPU 32 determines that the drawing processor 62 is in charge of the other processing, i.e., the color conversion processing and the screen processing (step S206).

Note that when it is determined that the drawing processors 61 and 62 are to perform the image processing, the power of the drawing processor 63 is turned OFF.

At step S204, when it is determined that the total value of the processing times for the JPEG decompression processing and the expansion/reduction processing is longer than the required image processing time (Yes at step S204), it is impossible to complete the JPEG decompression processing and the expansion/reduction processing by one drawing processor within the required image processing time. Accordingly, the drawing control CPU 32 determines that the drawing processor 61 is in charge of only the JPEG decompression processing (step S207). Then the drawing control CPU 32 determines that the drawing processor 62 is in charge of only the expansion/reduction processing (step S208). Finally, the drawing control CPU 32 determines that the drawing processor 63 is in charge of the other processing, i.e. the color conversion processing and the screen processing (step S209).

Note that the algorithm for selection of drawing processor shown in the flowchart of FIG. 9 is merely an example, and any other algorithm may be used as long as the number of necessary drawing processors and image processing steps to be performed by the respective drawing processors is determined.

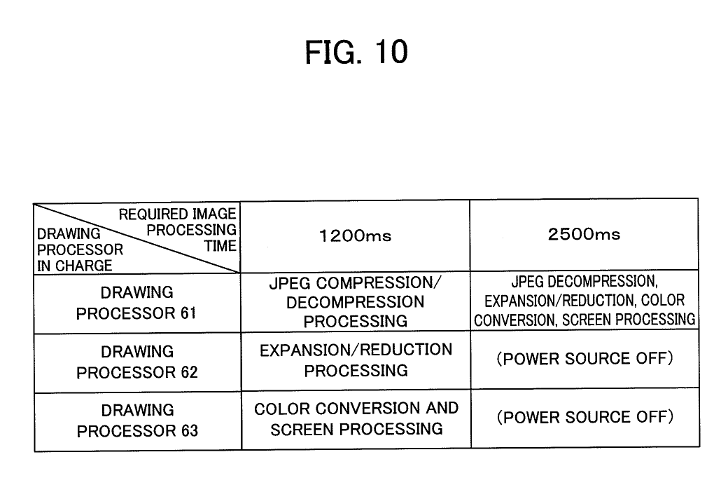

By the above-described determination, even when the contents of image processing required with the image processing command are the same, the number of necessary drawing processors is changed in correspondence with the required processing time. FIG. 10 shows changes of the number of necessary drawing processors in correspondence with required processing time.

For example, in the image processing command shown in FIG. 5, since the required processing time is 2500 ms, it is determined that the drawing processor 61 is in charge of all the image processing. However, assuming that the required processing time is 1200 ms in the image processing command shown in FIG. 5, it is determined that the three drawing processor 61 to 63 are in charge of the respective image processing.

In the above-described exemplary embodiment, the present invention is applied to an image forming system to perform printing on a continuous sheet; however, the present invention is not limited to this system. For example, the present invention is similarly applicable to an image forming system to perform printing on a cut sheet.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a plurality of drawing processing units that perform the image processing based on designation of an image processing command, the image processing command designating a plurality of input types of image processing;
a determination unit that determines whether the respective image processing designated with the image processing command is performed by one of the plurality of drawing processing units, or performed by the plurality of drawing processing units, based on image processing time necessary for execution of the respective image processing designated with the image processing command; and
a power source controller that, in a case where the determination unit determines that the respective image processing designated with the image processing command is performed by one of the plurality of drawing processing units, reduces power consumption of other drawing processing units than the one drawing processing unit, in comparison with a case where the respective image processing designated with the image processing command is performed by the plurality of drawing processing units.

2. The image processing apparatus according to claim 1, wherein in a case where the determination unit determines that the respective image processing designated with the image processing command is performed by one of the plurality of drawing processing units, the power source controller reduces the power consumption by blocking power to the other drawing processing units than the one drawing processing unit.

3. The image processing apparatus according to claim 1, wherein in a case where the determination unit determines that the respective image processing designated with the image processing command is performed by one of the plurality of drawing processing units, the power source controller reduces the power consumption by changing the other drawing processing units than the one drawing processing unit into a power saving status.

4. The image processing apparatus according to claim 1,
wherein the image processing command includes required processing time as time within which completion of execution of image processing is required, and
the determination unit calculates image processing time necessary for execution of the respective image processing included in the image processing command, and determines whether the respective image processing designated with the image processing command is performed by one of the plurality of drawing processing units, or the respective image processing designated with the image processing command is performed by the plurality of drawing processing units, based on a calculated value and the required processing time.

5. The image processing apparatus according to claim 1,
wherein the plurality of drawing processing units include:
a plurality of computing units;
a storage unit that stores connection information to realize an image processing function; and
a function realization unit that realizes a required image processing function by combining the plurality of computing units based on the connection information stored in the storage unit, in correspondence with an external request.

6. An image forming system comprising:
an image processing apparatus including:
a plurality of drawing processing units that perform the image processing based on designation of an image processing command, the image processing command designating a plurality of input types of image processing;
a determination unit that determines whether the respective image processing designated with the image processing command is performed by one of the plurality of drawing processing units, or performed by the plurality of drawing processing units, based on image processing time necessary for execution of the respective image processing designated with the image processing command; and
a power source controller that, in a case where the determination unit determines that the respective image processing designated with the image processing command is performed by one of the plurality of drawing processing units, reduces power consumption of other drawing processing units than the one drawing processing unit, in comparison with a case where the respective image processing designated with the image processing command is performed by the plurality of drawing processing units; and
an image output apparatus that outputs an image based on image information subjected to image processing by the image processing apparatus.

7. An image processing method comprising:
designating a plurality of input types of image processing with an image processing command;
performing the image processing based on designation of the image processing command by a plurality of drawing processing units;
determining whether the respective image processing designated with the image processing command is performed by one of the plurality of drawing processing units, or performed by the plurality of drawing processing units, based on image processing time necessary for execution of the respective image processing designated with the image processing command; and
in a case where it is determined that the respective image processing designated with the image processing command is performed by one of the plurality of drawing processing units, reducing power consumption of other drawing processing units than the one drawing processing unit, in comparison with a case where the respective image processing designated with the image processing command is performed by the plurality of drawing processing units.

8. A computer readable medium storing a program causing a computer to execute a process for image processing, the process comprising:
designating a plurality of input types of image processing with an image processing command;
performing the image processing based on designation of the image processing command by a plurality of drawing processing units;
determining whether the respective image processing designated with the image processing command is performed by one of the plurality of drawing processing units, or performed by the plurality of drawing processing units, based on image processing time necessary for execution of the respective image processing designated with the image processing command; and
in a case where it is determined that the respective image processing designated with the image processing command is performed by one of the plurality of drawing processing units, reducing power consumption of other drawing processing units than the one drawing processing unit, in comparison with a case where the respective image processing designated with the image processing command is performed by the plurality of drawing processing units.
